(19) United States
(12) Patent Application Publication
(10) Pub. No.: US 2008/0068385 A1
(43) Pub. Date: Mar. 20, 2008

(54) APPARATUS AND METHOD FOR CHANGING A SCREEN IN A PORTABLE TERMINAL

(75) Inventor: Young-Ho Kim, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 11/850,839

(22) Filed: Sep. 6, 2007

(30) Foreign Application Priority Data
Sep. 15, 2006 (KR) 10-2006-0089743

(51) Int. Cl. G06T 11/00

(52) U.S. Cl. 345/472

(57) ABSTRACT

An apparatus and method for changing a screen size in a portable terminal are provided. In the apparatus and method, an input portion provides a request for a change to one of a specific font, a specific font size, and a specific screen size. A font adjuster changes a current font to the specific font for a display, upon receipt of the request for a change to the specific font from the input portion, a font size adjuster changes a current font size to the specific font size for the display, upon receipt of the request for a change to the specific font size from the input portion, and a screen size adjuster changes a current screen size to the specific screen size for the display, upon receipt of the request for a change to the specific screen size from the input portion.

### PRIORITY

This application claims the benefit under 35 U.S.C. §119 of a Korean patent application filed in the Korean Intellectual Property Office on Sep. 15, 2006 and assigned Serial No. 2006-0089743, the entire disclosure of which is hereby incorporated by reference.

### BACKGROUND OF THE INVENTION

1. Field of the Invention

The present invention relates generally to changing a screen in a portable terminal. More particularly, the present invention relates to a method and apparatus for changing a font size, a font, or a screen size on a display of a portable terminal through a simple manipulation.

2. Description of the Related Art

Provisioning of services with diverse Quality of Service (QoS) classes at or above 100 Mbps to users is an active study area for a future-generation communication system called the 4th Generation (4G) system. Particularly, active research on provisioning of high-speed service by ensuring mobility and QoS to a Broadband Wireless Access (BWA) communication system such as Wireless Local Area Network (WLAN) and Wireless Metropolitan Area Network (WMAN) is on-going. Pertinent examples are the Institute of Electrical and Electronics Engineers (IEEE) standards 802.16d and IEEE 802.16e.

The IEEE 802.16d and IEEE 802.16e communication systems adopt Orthogonal Frequency Division Multiplexing (OFDM)/Orthogonal Frequency Division Multiple Access (OFDMA) for physical channels to support broadband transmission networks of WMAN systems. IEEE 802.16d considers only a single-cell structure with no regard to mobility of Subscriber Stations (SSs). In contrast, IEEE 802.16e supports the SSs'. A mobile SS is called a Mobile Station (MS). Hereinbelow, MSs and SSs are referred to as portable terminals that are defined as any kind of terminals that a user can carry.

Orthogonality between subcarriers, inherent to the nature of OFDM/OFDMA, leads to optimal transmission efficiency, a good frequency use efficiency, and robustness against multipath fading during high-speed data transmission in the IEEE 802.16e communication system.

In OFDM/OFDMA, to increase channel utilization between a plurality of portable terminals and a Base Station (BS) in a cell, subchannels are formed with subcarriers that can be shared among users and allocated to the portable terminals.

Worldwide Interoperability for Microwave Access (WiMAX), Wireless Broadband (WiBro), and Mobile WiMAX are IEEE 802.16d/e-compliant. A WiBro-enabled portable terminal is usually a laptop or Personal Digital Assistant (PDA) with a Personal Computer Memory Card International Association (PCMCIA) card inserted.

Due to its compact size, a personal portable terminal like a PDA generally has a screen of a limited size.

A limited screen size is not a great concern for conventional mobile phones designed mainly for voice calling. However, a limited screen size of a portable terminal in a packet data-centered BWA communication system such as WiBro or WiMAX causes an inconvenience to users when browsing Web pages or reading articles or text.

Furthermore, this inconvenience becomes more serious to people with poor eyesight. When it comes to font, portable terminals offer manufacturer-set fonts without diversification to users.

### SUMMARY OF THE INVENTION

An aspect of the present invention is to address at least the above mentioned problems and/or disadvantages and to provide at least the advantages described below. Accordingly, an aspect of the present invention is to provide a method and apparatus for changing a screen in a portable terminal.

Another aspect of the present invention is to provide a method and apparatus for changing a font size, a font, or a screen size on a display of a portable terminal through a simple manipulation so as to meet individual needs of users.

According to one aspect of the present invention, a portable terminal capable of changing a screen size is provided. In the portable terminal capable of changing a screen size, an input portion provides a request for a change to one of a specific font, a specific font size, and a specific screen size, a font adjuster changes a current font to the specific font for a display, upon receipt of the request for a change to the specific font from the input portion, a font size adjuster changes a current font size to the specific font size for the display, upon receipt of the request for a change to the specific font size from the input portion, and a screen size adjuster changes a current screen size to the specific screen size for the display, upon receipt of the request for a change to the specific screen size from the input portion.

According to another aspect of the present invention, a method for changing a screen in a portable terminal is provided. In the method for changing a screen, a change request is received, input of a selected font size is received if the change request includes a change in font size, and a current font size is changed to the selected font size for a display.

### BRIEF DESCRIPTION OF THE DRAWINGS

The above and other objects, features and advantages of certain exemplary embodiments of the present invention will become more apparent from the following detailed description when taken in conjunction with the accompanying drawings in which:

FIG. 1 is a block diagram illustrating a portable terminal according to an exemplary embodiment of the present invention;

FIG. 2 is a flowchart illustrating an operation for changing a font size according to an exemplary embodiment of the present invention;

FIG. 3 is a flowchart illustrating an operation for changing a font according to an exemplary embodiment of the present invention;

FIGS. 4A and 4B illustrate apparatus for changing a font size, a font, or a screen size according to exemplary embodiments of the present invention;

FIGS. 5A and 5B illustrate screen displays with adjusted font sizes according to an exemplary embodiment of the present invention;

FIGS. 6A and 6B illustrate screen displays before changing a font and a screen display after changing the font according to an exemplary embodiment of the present invention;

FIG. 7 is a flowchart illustrating an operation for changing a screen size according to an exemplary embodiment of the present invention; and

FIGS. 8A and 8B illustrate screen displays with changed screen sizes according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention is intended to provide an apparatus and method for changing a screen in a portable terminal.

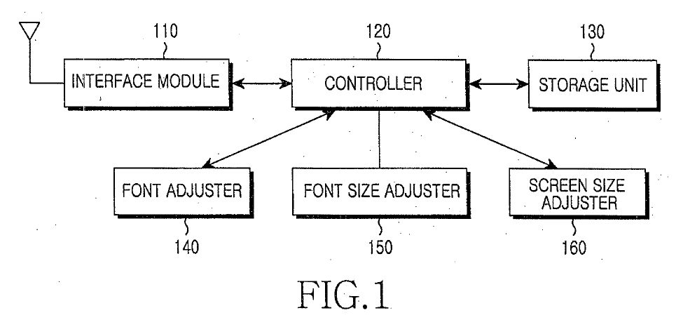

FIG. 1 is a block diagram illustrating components of a portable terminal according to an exemplary embodiment of the present invention.

Referring to FIG. 1, in addition to its typical functionalities including control of a voice call and data communication, a controller 120 controls a font adjuster 140, a font size adjuster 150, and a screen size adjuster 160 in the portable terminal.

Upon receipt of a request for a font change through an input portion (not shown) from a user, the font adjuster 140 outputs available fonts on a display (not shown). When the user selects a desired font through the input portion from among the displayed fonts, the font adjuster 140 sets the selected font for the display.

Upon receipt of a request for a font size change through the input portion from the user, the font size adjuster 150 displays different font sizes on the display. When the user selects a desired font size, the font size adjuster 150 sets the selected font size for the display.

If a font size is increased and thus less text is accommodated on a screen, a window size control bar or scroll bar is created and displayed so that the user can read the text by moving over the screen.

When the screen size adjuster 160 receives a request for a screen size change through the input portion from the user, it shows screens of different sizes on the display. If the user selects a specific screen size, the screen size adjuster 160 sets the selected screen size for the display. When an enlarged screen accommodates less text, the window size control bar or scroll bar is created and displayed so that the user can read the text by moving over the screen.

Hence, the screen size adjuster 160 functions essentially as a magnifier. The size of a screen displayed on the display is easily adjusted by means of a hot button provided on the outside of the portable terminal. The change in screen size involves a change in the size of images displayed with text as well as a change in font size. Using a scroll bar, which appears or disappears depending on a screen size change, the user can view an entire screen.

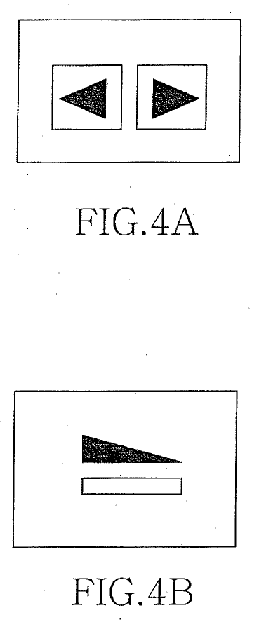

The input portion may operate in a digital manner using rectangular or similar pulses or in an analog manner using resistance variations. A detailed description of the input portion will be made later with reference to FIG. 4.

A storage unit 130 stores programs for overall control of the portable terminal and temporary data generated during executing of the programs. Particularly, the storage unit 130 stores fonts in accordance with an exemplary embodiment of the present invention.

An interface module 110 is a module for communicating with other nodes. It includes a Radio Frequency (RF) processor and a baseband processor. The RF processor downconverts an RF signal received through an antenna to a baseband signal and provides it to the baseband processor. It also upconverts a baseband signal received from the baseband processor to an RF signal transmittable in the air and transmits it through the antenna.

The controller 120 may incorporate the functionalities of the font adjuster 140, the font size adjuster 150, and the screen size adjuster 160.

The font adjuster 140, the font size adjuster 150, and the screen size adjuster 160 are configured separately in an exemplary embodiment, for illustrative purposes of differentiating their functions. Therefore, the controller 120 can incorporate all or part of the font adjuster 140, the font size adjuster 150, and the screen size adjuster 160.

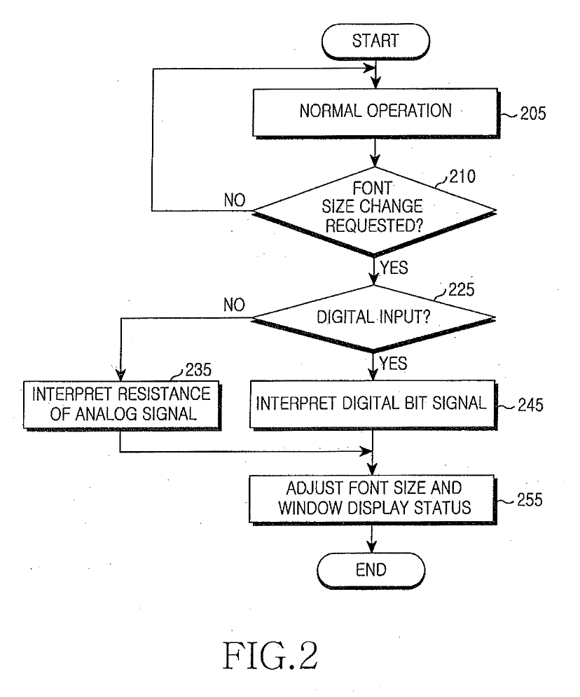

FIG. 2 is a flowchart illustrating an operation for changing a font size according to an exemplary embodiment of the present invention.

Referring to FIG. 2, the controller performs a normal operation such as a voice call, data communication, or waiting in idle mode in step 205.

Upon receipt of a font size change request from the input portion in step 210, the controller determines whether the input portion operates in the digital manner in step 225.

If the input portion operates in the digital manner, the controller determines whether the request is about a font size increase or decrease by interpreting received digital bits in step 245.

If the input portion operates in the analog manner, the controller determines whether the request is about a font size increase or decrease by interpreting the resistance of a received analog signal in step 235.

In step 255, the controller increases or decreases the font size according to the interpretation result of step 235 or step 245. When the user stops adjusting the font size at a specific font size through the input portion, the specific font size is selected. Or, upon input of a font size in any other way, the font size is selected.

If the font size is increased and thus less text is accommodated on a screen, a window size control bar or scroll bar is created and displayed so that the user can read the text by moving over the screen using the window size control bar.

Then the algorithm of the exemplary embodiment ends.

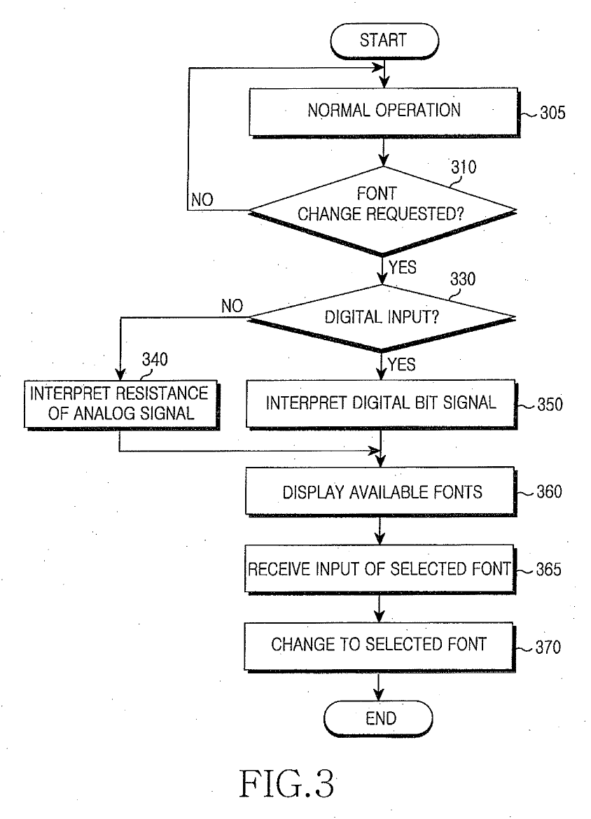

FIG. 3 is a flowchart illustrating an operation for changing a font according to an exemplary embodiment of the exemplary embodiment.

Referring to FIG. 3, the controller performs a normal operation such as voice call, data communication, or waiting in idle mode in step 305.

Upon receipt of a font change request from the input portion in step 310, the controller determines whether the input portion operates in the digital manner in step 330.

If the input portion operates in the digital manner, the controller displays available fonts on the display in step 360 by interpreting received digital bits in step 350.

If the input portion operates in the analog manner, the controller displays the available fonts on the display in step 360 by interpreting the resistance of a received analog signal in step 340.

In step 365, the controller receives a user-selected font by interpreting a received signal in the manner of step 340 or step 350.

Then, the controller changes a current font to the selected font in step 370 and ends the algorithm of the exemplary embodiment.

FIGS. 4A and 4B illustrate an apparatus for changing a font size, a font, or a screen size according to exemplary embodiments of the present invention.

FIG. 4A illustrates a digital changing apparatus. Referring to FIG. 4A, one of two buttons is designated for size increase and the other is designated for size decrease. The size increase or decrease is determined using pulses resulting from pressing one or both of the buttons.

As to a font size change, one of the two buttons is designated for size increase and the other is designated for size decrease. The size increase or decrease is determined using pulses resulting from pressing the appropriate buttons. Each time a button is pressed, a character of a different size is displayed.

As to a font change, the two buttons are used to move a cursor over displayed available fonts. In the case of the digital operation, the user selects a specific font by pressing the two buttons at the same time or pressing a separately procured button. The changing apparatus may reside at a user-friendly position outside the portable terminal.

As to a screen size change, one of the two buttons is designated for size increase and the other is designated for size decrease. The size increase or decrease is determined using pulses resulting from pressing the buttons. Each time a button is pressed, a screen of a different size is displayed.

FIG. 4B illustrates an analog changing apparatus. Referring to FIG. 4B, as resistance varies according to the rotation direction of a wheel or control wheel, one direction is set for size increase and the opposite direction is set for size decrease. The size increase or decrease is determined according to a resistance variation resulting from wheel rotation.

As to a font size change, as resistance varies according to the rotation direction of the wheel or control wheel, one direction is set for size increase and the opposite direction is set for size decrease. The size increase or decrease is determined according to a resistance variation resulting from wheel rotation. Upon each rotation of the wheel, a character of a different size is displayed.

As to a font change, the wheel is rotated to move a cursor over displayed available fonts. In the case of the digital operation, the user selects a specific font using a wheel or control wheel with a switch function (i.e. a wheel button having the dual functions of wheeling and switching like that of a wheel mouse) or using a separately procured button. The changing apparatus may reside at a user-friendly position outside the portable terminal.

The analog wheel or control wheel may be replaced with a digital wheel or control wheel. In this case, two sensors are positioned on the wheel or control wheel and a rotation direction is determined by interpreting the digital pulse input sequence of a sensor that changes according to the rotation of the wheel or control wheel.

As to a screen size change, as resistance varies according to the rotation direction of the wheel or control wheel, one direction is set for size increase and the opposite direction is set for size decrease. The size increase or decrease is determined according to a resistance variation resulting from wheel rotation. Upon each rotation of the wheel, a screen of a different size is displayed.

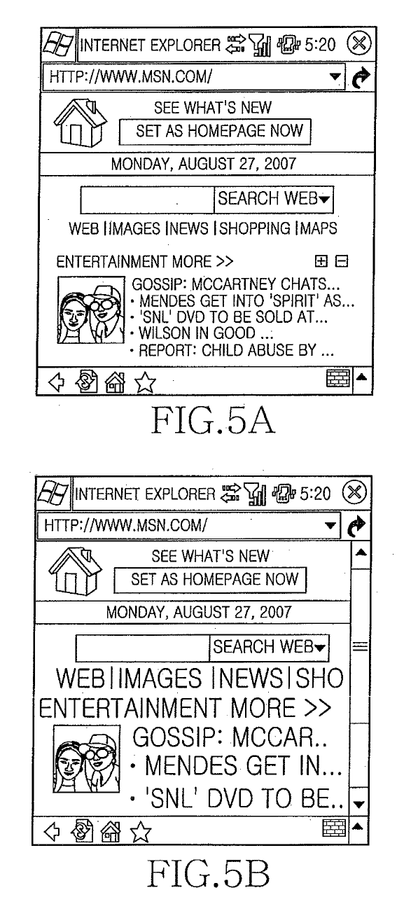

FIGS. 5A and 5B illustrate screen displays with adjusted font sizes according to an exemplary embodiment of the present invention.

Specifically, FIG. 5A illustrates a screen display with characters of a font size smaller than a default size, and FIG. 5B illustrates a screen display with characters of a font size larger than the default size. In FIG. 5B, as the screen displays less information due to the increased font size, a window size control bar is created so that the user can read the text by moving over the screen.

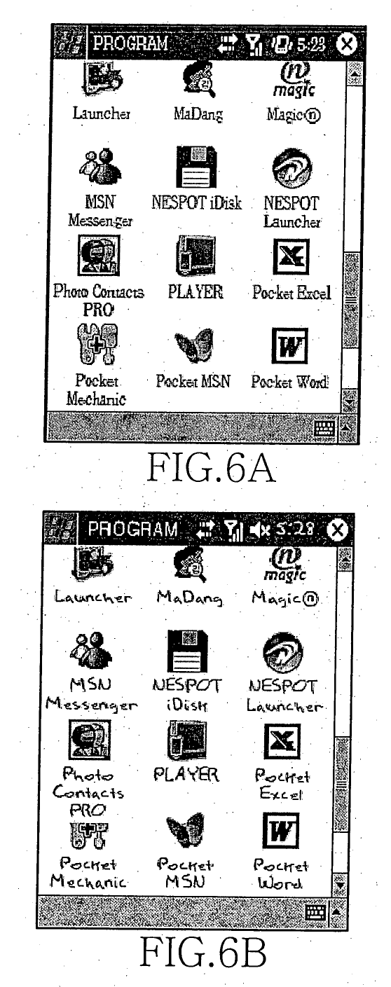

FIGS. 6A and 6B illustrate screen displays before changing a font and a screen display after changing the font according to an exemplary embodiment of the present invention.

Specifically, FIG. 6A illustrates characters of a default font on a screen and FIG. 6B illustrates characters of a different font on the screen. As the user selects a specific font, the default font illustrated in FIG. 6A is changed to the selected font illustrated in FIG. 6B on the screen.

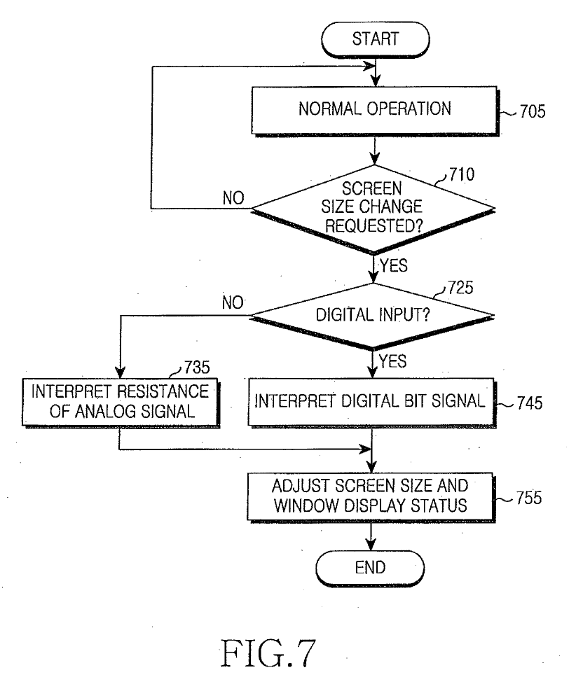

FIG. 7 is a flowchart illustrating an operation for changing a screen size according to an exemplary embodiment of the present invention.

Referring to FIG. 7, the controller performs a normal operation such as voice call, data communication, or waiting in idle mode in step 705.

Upon receipt of a screen size change from the input portion in step 710, the controller determines whether the input portion operates in the digital manner in step 725.

If the input portion operates in the digital manner, the controller determines whether the request is for a screen size increase or decrease by interpreting received digital bits in step 745.

If the input portion operates in the analog manner, the controller determines whether the request is for a screen size increase or decrease by interpreting the resistance of a received analog signal in step 735.

In step 755, the controller increases or decreases the screen size according to the interpretation result of step 735 or step 745. When the user stops adjusting the screen size at a specific screen size through the input portion, the specific screen size is selected. Or, upon input of a screen size in any other way, the screen size is selected.

If the screen size is increased and thus less text is accommodated on a screen, a window size control bar or scroll bar is created and displayed so that the user can read the text by moving over the screen using the window size control bar.

Thus, the procedure illustrated in FIG. 7 describes a magnifying function. The user can easily change the size of a displayed screen by a hot button provided outside the portable terminal. The change in screen size involves a change in the size of images displayed with text as well as a change in font size. Using a scroll bar, which appears or disappears depending on a screen size change, the user can view an entire screen.

Then the algorithm of the exemplary embodiment ends.

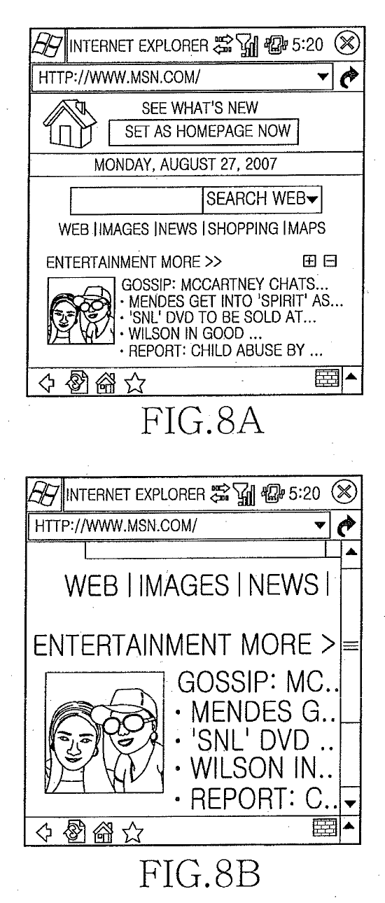

FIGS. 8A and 8B illustrate screen displays with changed screen sizes according to an exemplary embodiment of the present invention.

Specifically, FIG. 8A illustrates a screen display with a screen size smaller than a default size, and FIG. 8B illustrates a screen display with a screen size larger than the default size. In FIG. 8B, as the screen displays less information due to the increased screen size, a window size control bar is created so that the user can read the text by moving over the screen.

As is apparent from the above description, exemplary embodiments of the present invention advantageously adjust a font size, a font, or a screen size for a display of a limited size in a portable terminal through a simple operation, thereby meeting individual needs of users, in terms of eyesight and taste.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A portable terminal capable of changing a screen view, comprising:
an input portion for providing a request to change to at least one of a specific font, a specific font size and a specific screen size;
a font adjuster for changing a current font to the specific font for a display, upon receipt of the request to change to the specific font from the input portion;
a font size adjuster for changing a current font size to the specific font size for the display, upon receipt of the request to change to the specific font size from the input portion; and
a screen size adjuster for changing a current screen size to the specific screen size for the display, upon receipt of the request to change to the specific screen size from the input portion.

2. The portable terminal of claim 1, wherein the input portion further comprises at least one of a button and a dial for inputting the request for a change to the specific font.

3. The portable terminal of claim 1, wherein the input portion further comprises at least one of a button and a dial for inputting the request for a change to the specific font size.

4. The portable terminal of claim 1, wherein the input portion further comprises at least one of a button and a dial for inputting the request for a change to the specific screen size.

5. The portable terminal of claim 1, wherein upon receipt of the request to change the current font from the input portion, the font adjuster displays available fonts on the display, receives input of the specific font selected by a user, and changes the current font to the selected font for the display.

6. The portable terminal of claim 1, wherein upon receipt of the request to change the current screen size from the input portion, the screen size adjuster receives input of the specific screen size selected by a user, and changes the current screen size to the selected screen size for the display.

7. The portable terminal of claim 1, wherein upon receipt of the request to change the current font size from the input portion, the font size adjuster displays characters of different font sizes on the display, receives input of the specific font size selected by a user, and changes the current font size to the selected font size for the display.

8. The portable terminal of claim 1, wherein if the font size is increased such that all information cannot be simultaneously displayed, the font size adjuster generates a scroll bar so that a user can view the information by moving over the screen using the scroll bar.

9. The portable terminal of claim 1, wherein if the screen size is increased such that all information cannot be simultaneously displayed, the screen size adjuster generates a scroll bar so that a user can view the information by moving over the screen using the scroll bar.

10. A method for changing a screen in a portable terminal, comprising:
receiving a change request regarding at least one of a change in font size, a change in font and a change in screen size;
receiving input of a selected font size, if the change request regards a change in font size; and
changing a current font size to the selected font size for a display.

11. The method of claim 10, further comprising;
receiving input of a selected font, if the change request regards a change in font size; and
changing a current font to the selected font for the display.

12. The method of claim 10, further comprising;
receiving input of a selected screen size, if the change request regards a change in screen size; and
changing a current screen size to the selected screen size for the display.

13. The method of claim 10, wherein the receiving of the input of the selected font size comprises:
displaying characters of different font sizes on the display, upon receipt of the request for a change in font size; and
receiving the input of the font size selected from among the font sizes of the displayed characters.

14. The method of claim 11, wherein the receiving of the input of the selected font comprises:
displaying available fonts on the display, upon receipt of the request for a change in font; and
receiving the input of the font selected from among the displayed fonts.

15. The method of claim 12, wherein the receiving of the input of the selected screen size comprises:
displaying screens of different sizes on the display, upon receipt of the request for a change in screen size; and
receiving the input of the screen size selected from among the displayed screen sizes.

16. The method of claim 10, wherein the changing of the current font size further comprises, if the font size is increased and all information cannot be simultaneously displayed, generating a scroll bar so that a user can view the information by moving over the screen using the scroll bar.

17. The method of claim 12, wherein the changing of the screen size further comprises, if the screen size is increased and all information cannot be simultaneously displayed, generating a scroll bar so that a user can view the information by moving over the screen using the scroll bar.

18. The method of claim 10, wherein the receiving of the change request comprises receiving the change request through input of at least one of a pressing of a button and a rotating of a dial.

19. An apparatus capable of changing a screen size, comprising:
an input unit for providing a request to change to at least one of a specific font, a specific font size and a specific screen size;
a display unit for providing a user interface;
a font adjuster for changing a current font to the specific font for the display unit, upon receipt of the request to change to the specific font from the input portion;
a font size adjuster for changing a current font size to the specific font size for the display unit, upon receipt of the request to change to the specific font size from the input portion; and
a screen size adjuster for changing a current screen size to the specific screen size for the display unit, upon receipt of the request to change to the specific screen size from the input portion.

20. The apparatus of claim 19, wherein the input unit comprises a touch screen.
